(19) United States
(12) Patent Application Publication
(10) Pub. No.: US 2020/0247940 A1
(43) Pub. Date: Aug. 6, 2020

(54) STABLE ONE COMPONENT POLYURETHANE DISPERSIONS FOR VINYL WINDOWS

(71) Applicant: COVESTRO LLC, Pittsburgh, PA (US)

(72) Inventor: Makoto Nakao, Pittsburgh, PA (US)

(21) Appl. No.: 16/267,450

(22) Filed: Feb. 5, 2019

(51) Int. Cl. C08G 18/42; C08G 18/48; C08G 18/08; C08G 18/32; C08G 18/72; C08L 75/06; C08K 5/29

(52) U.S. Cl. CPC C08G 18/4213; C08G 18/48; C08G 18/0819; C08G 18/3225; C08J 7/047; C08G 18/72; C08L 75/06; C08K 5/29; C08L 2201/54; C08G 18/3203

(57) ABSTRACT

The present invention provides a stable, one-component polyurethane dispersion (PUD) based on ortho-phthalic based polyester polyols with a range of molecular weights. The stability is achieved by addition of from greater than about 1% to about 5% of a polycarbodiimide to the PUD. This chemistry provides coatings, adhesives, sealants, paints, primers, topcoats, and composites having excellent chemical resistance, especially with regard to aggressive detergent testing. The instant invention provides two-component performance with a one-component coating. The addition of a polycarbodiimide dispersion stabilizes a number of performance properties of the PUD over time such as, adhesion, detergent resistance, window cleaner resistance, 70% isopropyl alcohol resistance, pencil hardness, impact resistance, viscosity, pH, acid value, and pot life.

### FIELD OF THE INVENTION

The present invention relates in general to polymers and more specifically, to stable, one component polyurethane dispersions which adhere well to vinyl and a variety of other substrates.

### BACKGROUND OF THE INVENTION

As those skilled in the art are aware, it has proven very difficult to develop coatings which will adhere well to vinyl windows. This is because vinyl typically contains plasticizers such as dialkyl phthalates, alkyl aryl phosphates, alkyl aryl phthalates, aryl phosphates, etc., which interfere with the ability of the coating to adhere to the substrate.

In addition to the chemistry-related problems of trying to adhere a coating to vinyl, the American Architectural Manufacturers Association (AAMA) has very stringent standards for window coatings, including those for vinyl windows regarding a variety of parameters such as chemical resistance, detergent resistance, humidity resistance and pencil hardness.

In co-assigned U.S. Ser. No. 15/667,139 filed on Aug. 2, 2017, new, one component polyurethane dispersions are described which adhere well to vinyl. However, in working with those dispersions, the present inventor has observed in some instances, performance stability issues may be encountered.

Therefore, a need exists in the art for a coating which will adhere to vinyl and other substrates providing the necessary chemical, detergent, and humidity resistances and pencil hardness to permit the use in vinyl window and other coatings without exhibiting performance stability issues.

### SUMMARY OF THE INVENTION

Accordingly, the present invention addresses problems inherent in the art by providing stable, durable, chemically-resistant coatings, adhesives, sealants, paints, primers, topcoats, and composites that can be applied as a one-component, low VOC system.

The present invention provides a stable, one-component polyurethane dispersion (PUD) based on ortho-phthalic based polyester polyols with a range of molecular weights. This chemistry provides coatings, adhesives, sealants, paints, primers, topcoats, and composites having excellent chemical resistance, especially with regard to aggressive detergent testing. The instant invention provides two-component performance with a one-component coating. The addition of from greater than 1% to 5% of a polycarbodiimide to the formulation stabilizes a number of performance properties of the PUD over time, such as adhesion, detergent resistance, window cleaner resistance, 70% isopropyl alcohol resistance, pencil hardness, impact resistance, viscosity, pH, acid value, and pot life.

These and other advantages and benefits of the present invention will be apparent from the Detailed Description of the Invention herein below.

### BRIEF DESCRIPTION OF THE FIGURES

The present invention will now be described for purposes of illustration and not limitation in conjunction with the figures, wherein:

FIG. 1 shows a plot of pH (@40° C.) versus time in we eks;

FIG. 2 shows a plot of viscosity in mPas (@ 40° C.) versus time in weeks; and

FIG. 3 shows a plot of acid value in mg KOH/g (@40° C.) versus time in weeks.

### DETAILED DESCRIPTION OF THE INVENTION

The present invention will now be described for purposes of illustration and not limitation. Except in the operating examples, or where otherwise indicated, all numbers expressing quantities, percentages, and so forth in the specification are to be understood as being modified in all instances by the term “about.”

Any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited in this specification is intended to include all lower numerical limitations subsumed therein and any minimum numerical limitation recited in this specification is intended to include all higher numerical limitations subsumed therein. Accordingly, Applicants reserve the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112(a), and 35 U.S.C. § 132(a).

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicants reserve the right to amend this specification to expressly recite any subject matter, or portion thereof, incorporated by reference herein.

Reference throughout this specification to “various non-limiting embodiments,” “certain embodiments,” or the like, means that a particular feature or characteristic may be included in an embodiment. Thus, use of the phrase “in various non-limiting embodiments,” “in certain embodiments,” or the like, in this specification does not necessarily refer to a common embodiment, and may refer to different embodiments. Further, the particular features or characteristics may be combined in any suitable manner in one or more embodiments. Thus, the particular features or characteristics illustrated or described in connection with various or certain embodiments may be combined, in whole or in part, with the features or characteristics of one or more other embodiments without limitation. Such modifications and variations are intended to be included within the scope of the present specification. The various embodiments disclosed and described in this specification can comprise, consist of, or consist essentially of the features and characteristics as variously described herein.

The grammatical articles “a”, “an”, and “the”, as used herein, are intended to include “at least one” or “one or more”, unless otherwise indicated, even if “at least one” or “one or more” is expressly used in certain instances. Thus, these articles are used in this specification to refer to one or more than one (i.e., to “at least one”) of the grammatical objects of the article. By way of example, and without limitation, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

In a first aspect, the present invention is directed to a method of stabilizing at least one performance property of an aqueous polyurethane dispersion (PUD), the method comprising adding from >1% to about 5%, based on the weight of the aqueous polyurethane dispersion (PUD), of a polycarbodiimide, wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

In a second aspect, the present invention is directed to a method of stabilizing at least one performance property of an aqueous polyurethane dispersion (PUD), the method comprising adding from >1% to 5%, based on the weight of the aqueous polyurethane dispersion (PUD), of a polycarbodiimide, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono functional polyalkylene ether, (vii) a polyol having a molecular weight of less than <400 g/mol, and (viii) a polyamine or amino alcohol having a molecular weight of 32 to 400 g/mol, wherein the aqueous polyurethane dispersion (PUD) has a hard block content of greater than 50%, and wherein the at least one performance property is selected from the group consisting of adhesion according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

In a third aspect, the present invention is directed to an aqueous polyurethane dispersion (PUD) having at least one performance property stabilized, comprising the reaction product of (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C., (v) water; (vi) a mono fu nctional polyalkylene ether; (vii) a polyol having a molecular weight of less than <400 g/mol; (viii) a polyamine or amino alcohol having a molecular weight of 32 to 400 g/mol; and (ix) >1% to 5%, based on the weight of the aqueous polyurethane dispersion (PUD), of a polycarbodiimide, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to

ASTM D3363, impact resistance measured according to ASTM D2794, viscosity, pH, acid value, and pot life.

In a fourth aspect, the present invention is directed to one of a coating, an adhesive, a sealant, a paint, a primer, a topcoat, and a composite comprising an aqueous polyurethane dispersion (PUD) comprising the reaction product of a polyisocyanate, a polymeric polyol having a number average molecular weight of 400 to 8,000 g/mol, a compound comprising at least one isocyanate-reactive group and an anionic group or potentially anionic group, an amorphous polyester having a glass transition temperature (Tg) as determined by differential scanning calorimetry (DSC) of less than −30° C., water, a mono functional polyalkylene ether, a polyol having a molecular weight of less than <400 g/mol, a polyamine or amino alcohol having a molecular weight of 32 to 400 g/mol, and >1% to about 5%, based on the weight of the aqueous polyurethane dispersion (PUD), of a polycarbodiimide, wherein the aqueous polyurethane dispersion (PUD) has a hard block content of greater than 50%, and wherein at least one performance property of the coating, adhesive, sealant, paint, primer, topcoat, or composite is stabilized over time, the property selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

In a fifth aspect, the present invention is directed to a method of stabilizing at least one performance property of one of a coating, an adhesive, a sealant, a paint, a primer, a topcoat, and a composite, comprising an aqueous polyurethane dispersion (PUD), the method comprising adding to the aqueous polyurethane dispersion (PUD) from >1% to 5%, based on the weight of the aqueous polyurethane dispersion (PUD), of a polycarbodiimide, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono functional polyalkylene ether, (vii) a polyol having a molecular weight of less than <400 g/mol, and (viii) a polyamine or amino alcohol having a molecular weight of 32 to 400 g/mol, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

The inventive aqueous polyurethane dispersion (PUD) provides coatings, adhesives, sealants, paints, primers, topcoats, and composites having excellent chemical resistance, especially with regard to aggressive detergent testing. The addition of a polycarbodiimide to the aqueous polyurethane dispersion (PUD) stabilizes a number of performance properties of the coatings, adhesives, sealants, paints, primers, topcoats, and composites over time, such as adhesion, detergent resistance, window cleaner resistance, 70% isopropyl alcohol resistance, pencil hardness, impact resistance, viscosity, pH, acid value, and pot life.

Coatings, adhesives, sealants, paints, primers, topcoats, and composites made from the inventive aqueous polyurethane dispersion (PUD) pass detergent resistance testing according to the American Architectural Manufacturers Association's standard, AAMA 615-13, with a minimum 90% gloss retention, no blistering or loss of adhesion after testing and is unaffected by window cleaner according to AAMA 615-13. The inventive polyurethane dispersions are particularly well suited for use in or as coatings, adhesives, sealants, paints, primers, and topcoats applied to vinyl and other substrates, including but not limited to, floors, windows, doors, window frames, window surrounds, door frames, window shutters, railing, gates, pillars, arbors, pergolas, trellises, gazebos, posts, fencing, pipes and fittings, wire and cable insulation, automobile components, credit cards, cladding and siding.

As used herein, “polymer” encompasses prepolymers, oligomers and both homopolymers and copolymers; the prefix “poly” in this context referring to two or more. As used herein, “molecular weight”, when used in reference to a polymer, refers to the number average molecular weight (“Me”), unless otherwise specified. As used herein, the Mₙ of a polymer containing functional groups, such as a polyol, can be calculated from the functional group number, such as hydroxyl number, which is determined by end-group analysis.

As used herein, the term “coating composition” refers to a mixture of chemical components that will cure and form a coating when applied to a substrate. As used herein, a “coating” means a layer of any substance spread over a surface.

The terms “adhesive” or “adhesive compound”, refer to any substance that can adhere or bond two items together. Implicit in the definition of an “adhesive composition” or “adhesive formulation” is the concept that the composition or formulation is a combination or mixture of more than one species, component or compound, which can include adhesive monomers, oligomers, and polymers along with other materials.

A “sealant composition” refers to a composition which may be applied to one or more surfaces to form a protective barrier, for example, to prevent ingress or egress of solid, liquid or gaseous material or alternatively to allow selective permeability through the barrier to gas and liquid. In particular, it may provide a seal between surfaces.

As used herein, the term “paint” refers to a substance used for decorating or protecting a surface, and is typically a mixture containing a solid pigment suspended in a liquid, that when applied to a surface dries to form a hard, protective coating.

As used herein, “primer” refers to a substance used as a preparatory coat on previously an unpainted or uncoated surface to prevent the absorption of subsequent layers of coating or paint.

As used herein, “topcoat” refers to a transparent or translucent coat applied over the underlying material as a sealer. In a paint system, the topcoat provides a seal over the intermediate coat(s) and the primer.

A “composite” refers to a material made from two or more polymers, optionally containing other kinds of materials. A composite has different properties from those of the individual polymers/materials which make it up.

“Cured,” “cured composition” or “cured compound” refers to components and mixtures obtained from reactive curable original compound(s) or mixture(s) thereof which have undergone chemical and/or physical changes such that the original compound(s) or mixture(s) is(are) transformed into a solid, substantially non-flowing material. A typical curing process may involve crosslinking. Suitable crosslinking additives include, but are not limited to, polyisocyanates, aziridines, and carbodiimides.

The term “curable” means that an original compound(s) or composition material(s) can be transformed into a solid, substantially non-flowing material by means of chemical reaction, crosslinking, radiation crosslinking, or the like. Thus, compositions of the invention are curable, but unless otherwise specified, the original compound(s) or composition material(s) is(are) not cured.

As used herein, “stabilized”, “stabilizing” and “stability” with regard to the aqueous polyurethane dispersion (PUD) means that the dispersion and those coatings, adhesives, sealants, paints, primers, topcoats, and composites, made from the dispersion exhibit consistent physical performance over time as measured by one or more of the following properties: adhesion, detergent resistance, window cleaner resistance, 70% isopropyl alcohol resistance, pencil hardness, impact resistance, viscosity, pH, acid value, and pot life. In various non-limiting embodiments, the physical property will vary by less than 30%, by less than 20%, by less than 10%, in certain embodiments by less than 5%, and in selected embodiments by less than 3%.

As used herein, “soft blocks” contain polyethers, polyesters and polycarbonates and “hard blocks” contain urethanes, urea groups, short chain amines, diols and diisocyanates. In some embodiments, the inventive compositions have a hard block content of greater than 50%. In certain other embodiments, the inventive compositions have a hard block content of 50% to 60%. In various embodiments, the inventive compositions have a hard block content of 55% to 60%.

The term “pot life” as used herein means the time from combining the components, i.e., the PUD and the polycarbodiimide to the point at which the mixture is no longer useable. For example, the time that a significant physical performance drop is observed and/or a significant coating viscosity increase, which is no longer applicable, is observed. It is also called the working time or useable life.

As used herein, the term “aliphatic” refers to organic compounds characterized by substituted or un-substituted straight, branched, and/or cyclic chain arrangements of constituent carbon atoms. Aliphatic compounds do not contain aromatic rings as part of the molecular structure thereof. As used herein, the term “cycloaliphatic” refers to organic compounds characterized by arrangement of carbon atoms in closed ring structures. Cycloaliphatic compounds do not contain aromatic rings as part of the molecular structure thereof. Therefore, cycloaliphatic compounds are a subset of aliphatic compounds. Therefore, the term “aliphatic” encompasses aliphatic compounds and cycloaliphatic compounds.

As used herein, “diisocyanate” refers to a compound containing two isocyanate groups. As used herein, “polyisocyanate” refers to a compound containing two or more isocyanate groups. Hence, diisocyanates are a subset of polyisocyanates.

As used herein, the term “dispersion” refers to a composition comprising a discontinuous phase distributed throughout a continuous phase. For example, “waterborne dispersion” and “aqueous dispersion” refer to compositions comprising particles or solutes distributed throughout liquid water. Waterborne dispersions and aqueous dispersions may also include one or more co-solvents in addition to the particles or solutes and water. As used herein, the term “dispersion” includes, for example, colloids, emulsions, suspensions, sols, solutions (i.e., molecular or ionic dispersions), and the like.

As used herein, the term “aqueous polyurethane dispersion” means a dispersion of polyurethane particles in a continuous phase comprising water. As used herein, the term “polyurethane” refers to any polymer or oligomer comprising urethane (i.e., carbamate) groups, urea groups, or both. Thus, the term “polyurethane” as used herein refers collectively to polyurethanes, polyureas, and polymers containing both urethane and urea groups, unless otherwise indicated.

In various non-limiting embodiments, the dispersions, coatings, paints, primers, and topcoats of the invention include n-methyl-2-pyrrolidone (NMP) in amounts up to 15 wt. %, in some embodiments up to 10 wt. % in other embodiments up to 7 wt. % and in certain embodiments up to 5 wt. %, based on the total weight of the dispersions, coatings, paints, primers, and topcoats of the present invention.

In certain embodiments, the aqueous polyurethane dispersion (PUD) comprises one or more polyurethanes that are the reaction product of reactants comprising, consisting essentially of, or, in some cases, consisting of: a polyisocyanate; a polymeric polyol having a number average molecular weight (“Me”) of 400 to 8,000 g/mol; and a compound comprising at least one isocyanate-reactive group and an anionic group or potentially anionic group.

Suitable polyisocyanates (i) include, but are not limited to, aromatic, araliphatic, aliphatic and cycloaliphatic polyisocyanates, such as, for example, 1,4-butylene diisocyanate, 1,6-hexamethylene diisocyanate (HDI), pentamethylene diisocyanate (PDI), isophorone diisocyanate (IPDI), 2,2,4- and 2,4,4-trimethyl-hexamethylene diisocyanate, the isomeric bis-(4,4′-isocyanatocyclohexyl)methanes or mixtures thereof of any desired isomer content, 1,4-cyclohexylene diisocyanate, 1,4-phenylene diisocyanate, 2,4- and/or 2,6-toluene diisocyanate or hydrogenated 2,4- and/or 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), (S)-alkyl 2,6-diisocyanato-hexanoates or (L)-alkyl 2,6-diisocyanatohexanoates.

Polyisocyanates having a functionality >2 can also be used if desired. Such polyisocyanates include modified diisocyanates having a uretdione, isocyanurate, urethane, allophanate, biuret, iminooxadiazine-dione and/or oxadiazinetrione structure, as well as unmodified polyisocyanates having more than 2 NCO groups per molecule, for example 4-isocyanatomethyl-1,8-octane diisocyanate (nonane triisocyanate) or triphenylmethane-4,4′,4″-triisocyanate.

In some embodiments of the present invention, polyisocyanates or polyisocyanate mixtures containing only aliphatically and/or cycloaliphatically bonded isocyanate groups are used that have a mean functionality of from 2 to 4, such as 2 to 2.6 or 2 to 2.4.

Polymeric polyols (ii) have a molecular weight Mn of from 400 to 8000 g/mol, such as 400 to 6000 g/mol or, in some cases, 500 to 3000 g/mol, 1000 to 3000 g/mol or 1500 to 3000 g/mol. In certain embodiments, these polymeric polyols have a hydroxyl number of from 20 to 400 mg KOH/g of substance, such as 20 to 300 mg KOH/g of substance, 20 to 200 mg KOH/g of substance or 20 to 100 mg KOH/g of substance. In certain embodiments, these polymeric polyols have a hydroxyl functionality of 1.5 to 6, such as 1.8 to 3 or 1.9 to 2.1. As will be appreciated, the Mn of a polymer containing functional groups, such as a polyol, can, as discussed earlier, be calculated from the functional group number, such as hydroxyl number, which is determined by end-group analysis. “Hydroxyl number”, as used herein, is determined according to DIN 53240.

Exemplary polymeric polyols (ii) include, for example, polyester polyols, polyacrylate polyols, polyurethane polyols, polycarbonate polyols, polyether polyols, polyester polyacrylate polyols, polyurethane polyacrylate polyols, polyurethane polyester polyols, polyurethane polyether polyols, polyurethane polycarbonate polyols, polyester polycarbonate polyols, phenol/formaldehyde resins, on their own or in mixtures.

Suitable polyether polyols include, for example, the polyaddition products of the styrene oxides, of ethylene oxide, propylene oxide, tetrahydrofuran, butylene oxide, epichlorohydrin, as well as their mixed-addition and graft products, as well as the polyether polyols obtained by condensation of polyhydric alcohols or mixtures thereof and those obtained by alkoxylation of polyhydric alcohols, amines and amino alcohols.

Suitable polyether polyols often have a hydroxyl functionality of 1.5 to 6.0, such as 1.8 to 3.0, a hydroxyl number of 20 to 700 mg KOH/g solid, such as 20 to 100, 20 to 50 or, in some cases 20 to 40 mg KOH/g solid, and/or a Mn of 400 to 4000 g/mol, such as 100 to 4000 or 1000 to 3000 g/mol.

Exemplary polyester polyols are the polycondensation products of di- as well as optionally tri- and tetra-ols and di- as well as optionally tri- and tetra-carboxylic acids or hydroxycarboxylic acids or lactones. Instead of the free polycarboxylic acids it is also possible to use the corresponding polycarboxylic acid anhydrides or corresponding polycarboxylic acid esters of lower alcohols to prepare the polyesters. Examples of suitable diols are ethylene glycol, butylene glycol, diethylene glycol, triethylene glycol, polyalkylene glycols such as polyethylene glycol, further 1,2-propanediol, 1,3-propanediol, 1,3-butanediol, 1,4-butanediol, 1,6-hexanediol and isomers, 1,8-octanediol, neopentyl glycol, 1,4-bishydroxymethyl-cyclohexane, 2-methyl-1,3-propanediol, 2,2,4-trimethyl-1,3-pentanediol, dipropylene glycol, polypropylene glycols, dibutylene glycol, polybutylene glycols, bisphenol A, tetrabromobisphenol A, lactone-modified diols, or hydroxypivalic acid neopentyl glycol ester. In order to achieve a functionality >2, polyols having a functionality of 3 can optionally be used proportionately, for example trimethylolpropane, glycerol, erythritol, pentaerythritol, trimethylolbenzene or trishydroxyethyl isocyanurate.

Suitable dicarboxylic acids are, for example, phthalic acid, isophthalic acid, terephthalic acid, tetrahydrophthalic acid, hexahydro-phthalic acid, cyclohexane-dicarboxylic acid, adipic acid, azelaic acid, sebacic acid, glutaric acid, tetrachlorophthalic acid, maleic acid, fumaric acid, itaconic acid, malonic acid, suberic acid, 2-methylsuccinic acid, 3,3-diethylglutaric acid, and/or 2,2-dimethylsuccinic acid. Anhydrides of those acids can likewise be used, where they exist. Thus, for the purposes of the present invention, anhydrides are included in the expression “acid”. Monocarboxylic acids, such as benzoic acid and hexanecarboxylic acid, can also be used, provided that the mean functionality of the polyol is 2. Saturated aliphatic or aromatic acids can be used, such as adipic acid or isophthalic acid. Trimellitic acid is a polycarboxylic acid which can also optionally be used.

Hydroxycarboxylic acids which can be used as reactants in the preparation of a polyester polyol having terminal hydroxyl groups are, for example, hydroxycaproic acid, hydroxybutyric acid, hydroxydecanoic acid, hydroxystearic acid and the like. Suitable lactones are, for example, ε-caprolactone, butyrolactone and their homologues.

In certain embodiments of the present invention, polymer polyol (ii) comprises or, in some cases, consists essentially of or consists of a polyester diol that is a reaction product of butanediol and one or more of neopentyl glycol, hexanediol, ethylene glycol, and diethylene glycol with adipic acid and one or more of phthalic acid and isophthalic acid, such as polyester polyols that are a reaction product of at least one of butanediol, neopentyl glycol, and hexanediol with at least one of adipic acid and phthalic acid.

Suitable polyester polyols, such as the foregoing polyester diols, often have a hydroxyl functionality of 1.5 to 6.0, such as 1.8 to 3.0, a hydroxyl number of 20 to 700 mg KOH/gram solid, such as 20 to 100, 20 to 80 or, in some cases 40 to 80 mg KOH/g solid, and/or a Mn of 500 to 3000 g/mol, such as 600 to 2500 g/mol.

Exemplary polycarbonate polyols are obtainable by reaction of carbonic acid derivatives, for example diphenyl carbonate, dimethyl carbonate or phosgene, with diols. Suitable diols include the diols mentioned earlier with respect to the preparation of polyester polyols. In some cases, the diol component contains from 40 wt. % to 100 wt. % 1,6-hexanediol and/or hexanediol derivatives, often containing ether or ester groups in addition to terminal OH groups, for example products which are obtained by reaction of one mole of hexanediol with at least one mole, preferably from one to two moles, of ε-caprolactone or by etherification of hexanediol with itself to form di- or tri-hexylene glycol. Polyether polycarbonate polyols can also be used.

The third component of the polyurethane dispersion (PUD) is a compound comprising at least one isocyanate-reactive group and an anionic group or potentially anionic group (iii). Exemplary such compounds are those which contain, for example, carboxylate, sulfonate, phosphonate groups or groups which can be converted into the above-mentioned groups by salt formation (potentially anionic groups), and which can be incorporated into the macromolecules by isocyanate-reactive groups, such as hydroxyl or amine groups, that are present.

Suitable anionic or potentially anionic compounds are, for example, mono- and di-hydroxycarboxylic acids, mono- and di-aminocarboxylic acids, mono- and di-hydroxysulfonic acids, mono- and di-aminosulfonic acids as well as mono- and di-hydroxyphosphonic acids or mono- and di-aminophosphonic acids and their salts, such as dimethylol-propionic acid, dimethylolbutyric acid, hydroxypivalic acid, N-(2-amino-ethyl)-β-alanine, 2-(2-amino-ethylamino)-ethanesulfonic acid, ethylene-diamine-propyl- or -butyl-sulfonic acid, 1,2- or 1,3-propylenediamine-3-ethylsulfonic acid, malic acid, citric acid, glycolic acid, lactic acid. In certain embodiments, the anionic or potentially anionic compounds have at least one of carboxy, carboxylate, and sulfonate groups and have a functionality of from 1.9 to 2.1, such as the salts of 2-(2-aminoethyl-amino)ethanesulfonic acid.

In certain embodiments, component (iii) is used in an amount of at least 0.1% by weight, such as at least 1%, or at least 3% by weight and/or no more than 10% by weight, such as no more than 7% by weight, based on the total weight of reactants used to make the polyurethane.

Amorphous polyesters (iv) are included in the inventive aqueous polyurethane dispersion (PUD) which have a glass transition temperature (T_{g}) as determined by differential scanning calorimetry (DSC) of less than −30° C. In various embodiments, these polyesters have a molecular weight of from 300 to 3000. In certain embodiments, these polyesters have a molecular weight of approximately 1000. In some embodiments the amorphous polyester (iv) comprises an ortho-phthalic anhydride/1,6-hexane diol.

Component (vi) is a mono functional polyalkylene ether that contains at least one, in some cases one, hydroxy or amino group. In some embodiments, component (vi) comprises compounds of the formula:

H—Y′—X—Y—R

in which R is a monovalent hydrocarbon radical having 1 to 12 carbon atoms, such as an unsubstituted alkyl radical having 1 to 4 carbon atoms; X is a polyalkylene oxide chain having 5 to 90, such as 20 to 70 chain members, which may comprise at least 40%, such as at least 65%, ethylene oxide units and which in addition to ethylene oxide units may comprise propylene oxide, butylene oxide and/or styrene oxide units; and Y and Y′ are each independently oxygen or —NR′— in which R′ is H or R, in which R is defined above.

Mono functional polyalkylene ethers suitable for use in component (vi) may, in some cases, contain 7 to 55 ethylene oxide units per molecule, and can be obtained by alkoxylation of suitable starter molecules, such as, for example, saturated monoalcohols, such as methanol, ethanol, n-propanol, isopropanol, n-butanol, isobutanol, sec-butanol, the isomeric pentanols, hexanols, octanols and nonanols, n-decanol, n-dodecanol, n-tetradecanol, n-hexadecanol, n-octadecanol, cyclohexanol, the isomeric methyl-cyclohexanols or hydroxymethyl-cyclohexane, 3-ethyl-3-hydroxymethyloxetan or tetrahydrofurfuryl alcohol; diethylene glycol monoalkyl ethers, such as, for example, diethylene glycol monobutyl ether; unsaturated alcohols, such as allyl alcohol, 1,1-dimethyl-allyl alcohol or oleic alcohol; aromatic alcohols, such as phenol, the isomeric cresols or methoxyphenols; araliphatic alcohols, such as benzyl alcohol, anis alcohol or cinnamic alcohol; secondary monoamines, such as dimethylamine, diethylamine, dipropylamine, diisopropylamine, dibutyl-amine, bis-(2-ethylhexyl)-amine, N-methyl- and N-ethyl-cyclohexylamine or dicyclohexylamine; as well as heterocyclic secondary amines, such as morpholine, pyrrolidine, piperidine or 1H-pyrazole, including mixtures of two or more of any of the foregoing.

Alkylene oxides suitable for the alkoxylation reaction include, for example, ethylene oxide and propylene oxide, which can be used in the alkoxylation reaction in any desired sequence or alternatively in admixture. In some embodiments, component (vi) comprises a copolymer of ethylene oxide with propylene oxide that contains ethylene oxide in an amount of at least 40% by weight, such as at least 50% by weight, at least 60% by weight or at least 65% by weight and/or up to 90% by weight or up to 80% by weight, based on the total weight of ethylene oxide and propylene oxide. In certain embodiments, the Mn of such a copolymer is 300 g/mol to 6000 g/mol, such as 500 g/mol to 4000 g/mol, such as 1000 g/mol to 3000 g/mol.

In certain embodiments, component (vi) is used in an amount of at least 1% by weight, such as at least 5%, or at least 10% by weight or no more than 30% by weight, such as no more than 20% by weight, based on the total weight of reactants used to make the polyurethane.

Component (vii) comprises a polyol having a molecular weight of less than <400 grams/mol. Examples of such polyols include, without limitation, the diols mentioned earlier with respect to the preparation of polyester polyols. In some cases, the polyol having a molecular weight of less than <400 g/mol has up to 20 carbon atoms, such as is the case with, for example, ethylene glycol, diethylene glycol, triethylene glycol, 1,2-propanediol, 1,3-propanediol, 1,4-butanediol, 1,3-butylene glycol, cyclohexanediol, 1,4-cyclohexanedimethanol, 1,6-hexanediol, neopentyl glycol, hydroquinone dihydroxyethyl ether, bisphenol A (2,2-bis(4-hydroxy-phenyl)propane), hydrogenated bisphenol A, (2,2-bis(4-hydroxycyclo-hexyl)propane), trimethylolpropane, glycerol, pentaerythritol and also any desired mixtures of two or more thereof. Also suitable are ester diols of the specified molecular weight range such as α-hydroxybutyl-ε-hydroxy-caproic acid ester, ω-hydroxyhexyl-γ-hydroxybutyric acid ester, β-hydroxy-ethyl adipate or bis(β-hydroxyethyl) terephthalate.

In certain embodiments, component (vii) is used in an amount of at least 1% by weight, such as at least 2%, or at least 3% by weight and/or no more than 20% by weight, such as no more than 10% or no more than 5% by weight, based on the total weight of reactants used to make the polyurethane.

Component (viii) is used for chain extension and includes di- or poly-amines as well as hydrazides, for example ethylenediamine, 1,2- and 1,3-diaminopropane, 1,4-diaminobutane, 1,6-diaminohexane, isophorone-diamine, isomer mixture of 2,2,4- and 2,4,4-trimethyl-hexamethylene-diamine, 2-methylpentamethylenediamine, diethylenetriamine, 1,3- and 1,4-xylylenediamine, α,α,α′,α′-tetramethyl-1,3- and -1,4-xylylenediamine and 4,4-diaminodicyclohexylmethane, dimethylethylenediamine, hydrazine or adipic acid dihydrazide. Also suitable for use are compounds which contain active hydrogen of different reactivity towards NCO groups, such as compounds which contain, in addition to a primary amino group, also secondary amino groups or, in addition to an amino group (primary or secondary), also OH groups. Examples thereof are primary/secondary amines, such as 3-amino-1-methyl-aminopropane, 3-amino-1-ethylaminopropane, 3-amino-1-cyclohexylaminopropane, 3-amino-1-methylaminobutane, also alkanolamines such as N-aminoethylethanol-amine, ethanolamine, 3-aminopropanol or neopentanolamine.

In certain embodiments, component (viii) is used in an amount of at least 1% by weight, such as at least 3% or at least 5% by weight and no more than 10% by weight, such as no more than 8% or, in some cases, no more than 7% by weight, based on the total weight of reactants used to make the polyurethane.

In various embodiments, the aqueous polyurethane dispersion (PUD) contains a polycarbodiimide component (ix). Polycarbondiimides are polymers containing the group:

N═C═N

and may be formed by self-addition polymerization of a diisocyanate using organo-phosphorous compounds or by anionic polymerization of a carbodiimide. In some embodiments, the polycarbondiimides are aliphatic, in other embodiments, the polycarbondiimides are aromatic, in certain embodiments, the polycarbondiimides are a mixture of aliphatic and aromatic. Suitable polyisocyanates for polymerization into polycarbodiimides (ix) for use in the present invention include, but are not limited to, those listed herein as suitable for use as component (i). Suitable carbodiimides include, but are not limited to, N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

In various non-limiting embodiments, the polycarbodiimide component (ix) is included in amounts of from >1% to 5%, based on the weight of the aqueous polyurethane dispersion (PUD); in certain embodiments, polycarbodiimide component (ix) is used in amounts of from 3% to 5%, based on the weight of the aqueous polyurethane dispersion (PUD). The polycarbodiimide component (ix) is preferably employed in the form of a dispersion, more preferably in the form of a waterborne dispersion. The present inventor has surprisingly found that the inclusion of polycarbodiimide component (ix) stabilizes a number of performance properties of the aqueous polyurethane dispersion (PUD), and coatings, adhesives, sealants, paints, primers, topcoats, and composites made therefrom, over time. Such performance properties include the following: detergent resistance, window cleaner resistance, 70% isopropyl alcohol resistance, pencil hardness, impact resistance, viscosity, pH, acid value, and pot life.

In various embodiments of the present invention, the aqueous polyurethane dispersion (PUD) has a glass transition temperature (Tg) as determined by differential scanning calorimetry (DSC) of 0° C. to 20° C. and a hard block content of greater than 50%. In certain embodiments, the hard block content is from 50% to 60% and in a preferred embodiment, the hard block content is from greater than 55% to 60%.

Any of a variety of processes can be used to prepare the aqueous polyurethane dispersion (PUD) of the present invention, such as the prepolymer mixing method, acetone method or melt dispersing method, each of which will be understood by a person skilled in the art of making aqueous polyurethane dispersions. For example, in some embodiments, the aqueous polyurethane dispersions of the present invention may be produced by the acetone method, such as is described, for example, in U.S. Patent Application Publication No. 2007/0167565 A1 at [0057]-[0073]. A most preferred process is described in co-assigned U.S. Ser. No. 15/667,139 filed on Aug. 2, 2017.

In certain embodiments, the resin solids content of the aqueous polyurethane dispersion (PUD) prepared by any of these methods is at least 20% by weight, such as at least 25% or at least 30% by weight or no more than 65% by weight, such as no more than 50% or no more than 45% by weight, based on the total weight of the dispersion.

Among the possible applications for the inventive aqueous polyurethane dispersion (PUD) is in or as a coating or paint for application on a frame of an architectural article, such as a vinyl door, door frame, window, window frame, window surrounds, window shutters, railing, gates, pillars, arbors, pergolas, trellises, gazebos, posts, fencing, cladding and siding, particularly those that are constructed of a material such as polyvinylchloride (PVC). In certain embodiments, the aqueous polyurethane dispersion (PUD) of the present invention may produce a cured coating that, when used on a frame of an architectural article, such as a door or window, meets or exceeds many if not all of the requirements of AAMA specification 615-13, “Voluntary Specification, Performance Requirements and Test Procedures for Superior Performing Organic Coatings on Plastic Profiles”, (referred to herein as “AAMA 615-13”). For example, cured coatings made from the aqueous polyurethane dispersion (PUD) of the present invention, when deposited over a low surface energy synthetic substrate, such as polyvinylchloride (PVC), may pass the detergent resistance test described in AAMA 615-13.

As used herein, “vinyl” means materials made by polymerizing an alkene group into a chain. Examples of vinyl compounds include, but are not limited to, polyvinylchloride (PVC), polystyrene (PS), polyvinyl acetate (PVAc), polyvinyl alcohol (PVOH), and polyacrylonitrile (PAN).

Other suitable substrates include, but are not limited to, wood, polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), concrete, masonry, textiles, metals, ceramics, composites, and glass.

The aqueous polyurethane dispersions (PUDs), coatings, adhesives, sealants, paints, primers, topcoats, and composites of the present invention may further include any of a variety of additives such as defoamers, devolatilizers, thickeners, flow control additives, colorants (including pigments and dyes), surfactants, dispersants, and neutralizers as is known to those skilled in the art.

The aqueous polyurethane dispersions (PUDs), coatings formulations and paint formulations of the present invention may be admixed and combined with the conventional paint-technology binders, auxiliaries and additives, selected from the group of pigments, dyes, matting agents, flow control additives, wetting additives, slip additives, pigments, including metallic effect pigments, fillers, nanoparticles, light stabilizing particles, anti-yellowing additives, thickeners, and additives for reducing the surface tension.

The aqueous polyurethane dispersions (PUDs), coatings, adhesives, sealants, paints, primers, and topcoats according to the invention can be applied to the substrate by the conventional techniques, such as, spraying, rolling, flooding, printing, knife-coating, pouring, brushing and dipping.

### EXAMPLES

The non-limiting and non-exhaustive examples that follow are intended to further describe various non-limiting and non-exhaustive embodiments without restricting the scope of the embodiments described in this specification. All quantities given in “parts” and “percents” are understood to be by weight, unless otherwise indicated. Although the present disclosure describes a coating in the Examples, those skilled in the art will appreciate it can also be equally applicable to an adhesive, a sealant, a paint, a primer, a topcoat, and a composite.

The following materials were used in preparation of the Examples:

| | |
|---|---|
| POLYOL A | ortho-phthalic anhydride/1,6-hexane diol, |
| | having a molecular weight of 1000, commer- |
| | cially availablefrom Stepan Co. as STEPANPOL |
| | PC-1028-115; |
| POLYOL B | a butyl-diglycol based PO/EO (15.6%/63.5%) |
| | monol capped with EO (20.9%) having a hydroxyl |
| | number of about 25 mg KOH/g, commercially |
| | available from Covestro as POLYETHER LB-25; |
| DISPERSION A | a waterborne dispersion of a hydrophilically |
| | modified, aliphatic polycarbodiimide, 40% by |
| | weight resin solids in water, commercially |
| | available from Covestro as DESMODUR XP 2802; |
| ISOCYANATE A | 4,4′-dicyclohexylmethane diisocyanate |
| | having an NCO group content of about 31.8% |
| | and a functionality of about 2, commercially |
| | available from Covestro as DESMODUR W; |
| SURFACTANT A | a nonionic wetting agent and molecular |
| | defoamer (75% active liquid in ethylene |
| | glycol) commercially available from Air |
| | Products as SURFYNOL 104H; |
| ADDITIVE A | dimethylolpropionic acid (DMPA); |
| ADDITIVE B | neopentylglycol (NPG); |
| ADDITIVE D | triethylamine (TEA); |
| ADDITIVE E | a mixture of hydrophobic solids and foam |
| | destroying polysiloxanes in polyglycol, |
| | commercially available from BYK Chemie |
| | as BYK-028; |
| ADDITIVE F | a polyether modified siloxane, commercially |
| | available from BYK Chemie as BYK-333; |
| ADDITIVE G | a solution of a polyether modified siloxane, |
| | commercially available from BYK Chemie as |
| | BYK-346; |
| ADDITIVE H | a fine-grained wax after-treated precipitated |
| | silica, commercially available from Evonik |
| | ACEMATT OK 520; |
| SOLVENT A | n-methyl-2-pyrrolidone (NMP); |
| SOLVENT B | diethylene glycol monobutyl ether, commercially |
| | available from The Dow Chemical Co. as butyl |
| | carbitol; |
| TINT A | a resin-free, water-based, free-flowing |
| | titanium dioxide pigment dispersion commer- |
| | cially available from Chromaflo Technologies |
| | as TINT-AYD CW 5003; |
| EXTENDER A | diethylenetriamine (DETA); |
| EXTENDER B | hydrazine hydrate, 64% (HyHy); and |
| EXTENDER C | ethylenediamine (EDA). |

Table I provides the formulation used to prepare the polyurethane dispersion (PUD-A) used in the Examples along with its properties.

The polyurethane dispersion was made by charging the specified amounts of the relevant POLYOL A, POLYOL F and ADDITIVE A and ADDITIVE B to a reaction vessel and heating the vessel to 70° C. The specified amount of ISOCYANTE A was added to the vessel and the vessel observed for an exothermic reaction. When the exothermic reaction was observed, the vessel was maintained at 95° C. The mixture was sampled an d assessed for percent NCO. The mixture was cooled to 80° C. and another sa mple removed and assessed for percent NCO. The specified amounts of ADDITIVE C and ADDITIVE D were added to the mixture and mixed for 20 minutes.

The resultant prepolymer was dispersed in the specified amount of water along with the specified amount of SURFACTANT A. EXTENDERS A, B and C were added dropwise and the mixture mixed for one hour while cooling to room temperature. The polyurethane dispersion was filtered through a 50 μm filter before use.

TABLE I

| | PUD-A |
|---|---|
| POLYOL A | 664.7 |
| POLYOL B | 57.7 |
| ADDITIVE A | 63.3 |
| ADDITIVE B | 68.9 |
| SOLVENT A | 350 |
| ADDITIVE D | 47.8 |
| EXTENDER A | 21.5 |
| EXTENDER B | 21.5 |
| EXTENDER C | 19.4 |
| WATER, DI | 2885.9 |
| SURFACTANT A | 8.6 |
| ISOCYANATE A | 790.8 |
| Properties | |
| % NCO | 5.04 |
| NCO/OH + NH | 1.04 |
| NCO:OH | 1.65 |
| % NMP | 7.0 |
| % COOH | 1.25 |
| % Solids | 34.00 |
| Chain ext. % | 90.19 |
| % neutralization | 100 |

PUD-A was combined with various amounts (0%, 1%, 3% and 5% of DISPERSION A) according to Table II and tested. The amounts of materials in Table II are normalized to 100 by weight.

TABLE II

| | Ex. A | Ex. B | Ex. C | Ex. D |
|---|---|---|---|---|
| PUD-A | 100.00 | 99.01 | 97.09 | 95.24 |
| DISPERSION A | 0 | 0.99 | 2.91 | 4.76 |
| % DISPERSION A | 0 | 1 | 3 | 5 |
| Properties | | | | |
| VOC | 1.63 | 1.61 | 1.58 | 1.55 |
| Volume solids | 30.93 | 31.01 | 31.15 | 31.29 |
| Weight solids | 35.00 | 35.05 | 35.15 | 35.24 |
| Wt/Gal. | 8.90 | 8.90 | 8.89 | 8.88 |

PUD-A +DISPERSION A Samples A, B, C, and D were tested at 0 weeks, two weeks and four weeks (storage at 40(C) a fter being made for viscosity, pH, percent solids, particle size (mean pm), acid value, The results of this testing is presented in Table III.

The viscosity of SAMPLES A, B, C, and D, was measured using a BROOKFIELD LVDV-1+ viscometer.

The pH of SAMPLES A, B, C, and D, was measured using an ACCUMET AB 15 pH meter.

The percent solids of SAMPLES A, B, C, and D, was determined using a METTLER-TOLEDO moisture analyzer.

The particle size of SAMPLES A, B, C, and D, was determined by a HORIBA LA-910 laser diffraction particle size analyzer.

The acid value in mg KOH/g of SAMPLES A, B, C, and D, was determined by a METTLER TOLEDO T90 titrator.

TABLE III

| | Storage | | | | | | | | | | | |
|---|---|---|---|---|---|---|---|---|---|---|---|---|
| | 0 weeks @ 40° C. | | | | 2 weeks @ 40° C. | | | | 4 weeks @ 40° C. | | | |
| Sample | A | B | C | D | A | B | C | D | A | B | C | D |
| Dispersion A | 0% | 1% | 3% | 5% | 0% | 1% | 3% | 5% | 0% | 1% | 3% | 5% |
| Viscosity* | 21.30 | 21.90 | 22.50 | 22.50 | 21.90 | 24.00 | 24.30 | 29.10 | 25.50 | 25.80 | 27.90 | 33.90 |
| pH | 7.86 | 7.94 | 7.81 | 8.03 | 7.99 | 8.05 | 8.06 | 8.16 | 8.07 | 8.17 | 8.06 | 8.13 |
| % solids | 34.64 | 34.61 | 35.43 | 34.60 | 34.27 | 34.54 | 35.06 | 34.81 | 35.01 | 35.01 | 34.68 | 34.76 |
| Particle size** | 0.08 | 0.08 | 0.08 | 0.08 | 0.08 | 0.08 | 0.08 | 0.09 | 0.08 | 0.08 | 0.08 | 0.08 |
| Acid value*** | 5.33 | 5.10 | 4.25 | 4.22 | 5.72 | 5.83 | 4.85 | 5.06 | 5.74 | 5.50 | 4.85 | 5.06 |

*in cps
**in μm (mean)
***in mgKOH/g

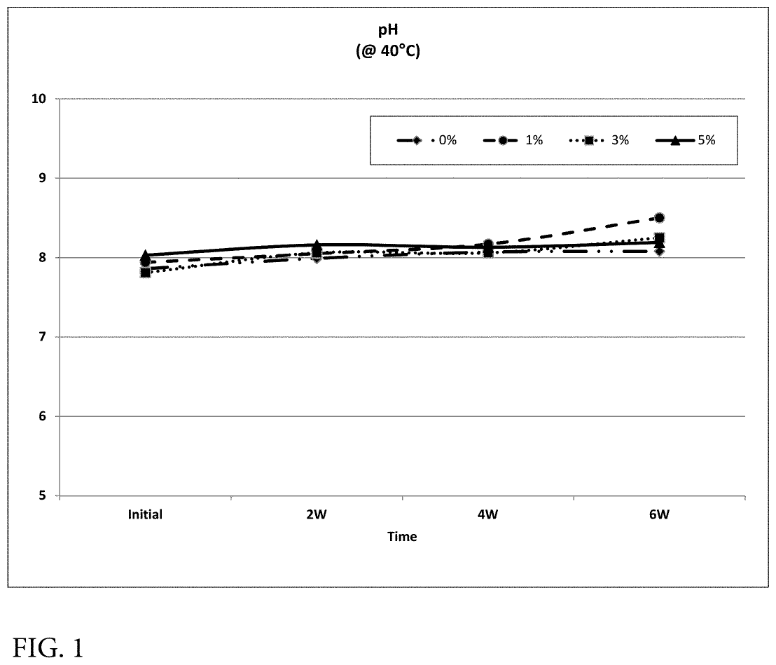

As can be appreciated by reference to Table III and FIG. 1, the pH of PUD-A was stable over time at 1% (circles, dashed line), 3% (squares, dotted line) and 5% (triangles, solid line) DISPERSION A levels.

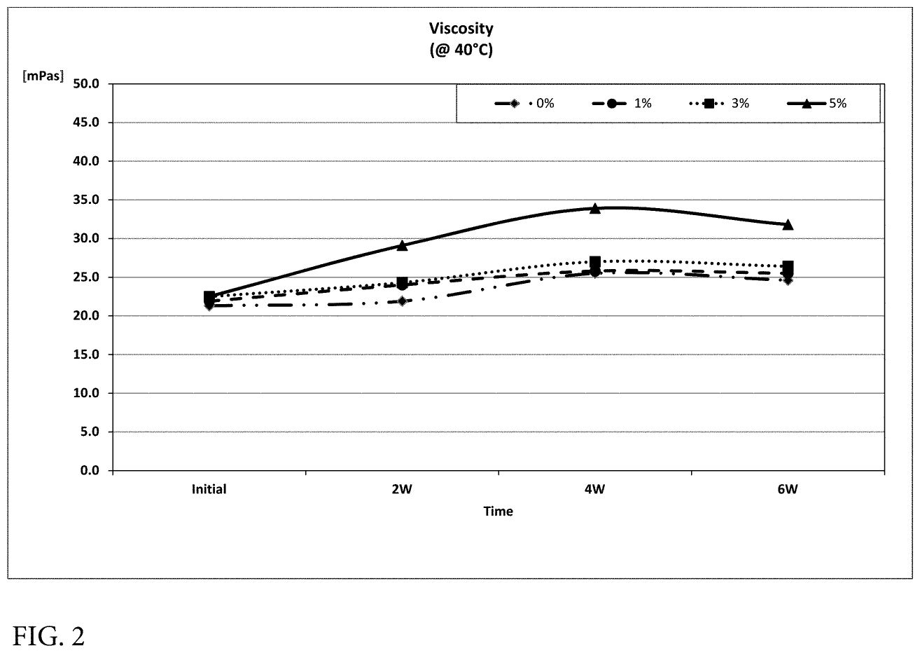

Further, as can be appreciated by reference to Table III and FIG. 2, there was no significant viscosity increase observed in PUD-A with 3% DISPERSION A (squares, dotted line). The PUD-A sample with 5% DISPERSION A (triangles, solid line) exhibited a slightly increased viscosity but after four weeks, the viscosity leveled.

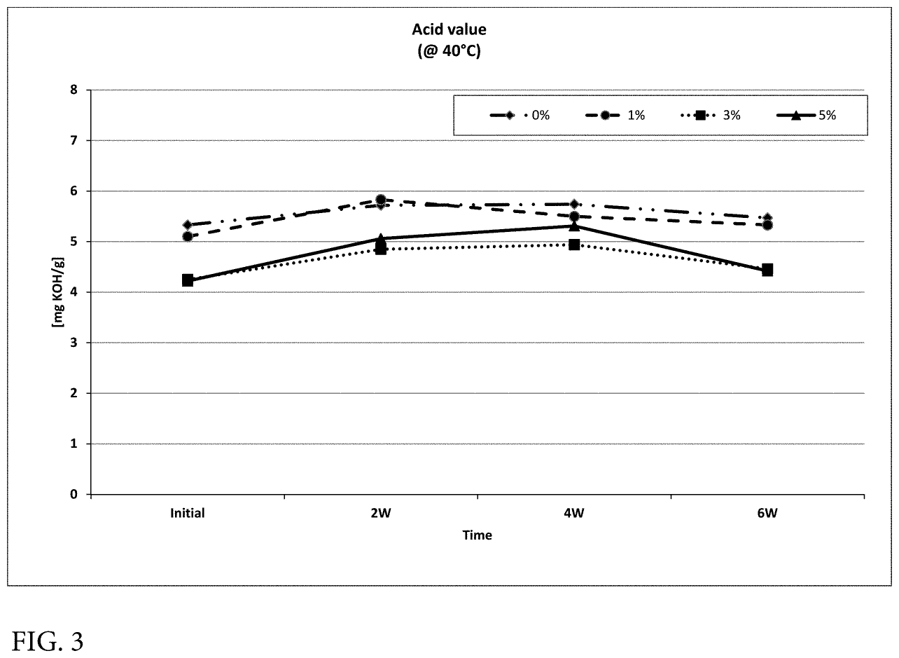

As can be appreciated by reference to Table III and FIG. 3, the initial acid value reduction with the inclusion of DISPERSION A in PUD-A indicated a reaction of carboxylic acid with carbodiimide. However, after mixing DISPERSION A, the acid value was fairly stable after six weeks at 40° C. Without wishing to be bound to any particular theory, the present inventor believes this is due to the good hydrolytic stability of PUD-A.

Films were made from the formulations for testing. The film thickness was 6 mils (wet) and the films were dried at 50° C. for 10 minutes (except for drying time at room temperature). All testing followed after an additional seven day rest at ambient temperature. When films were made on vinyl substrate for AAMA 615-13 test (Table IV), the following surface preparation method was conducted: the vinyl substrate was wiped with lacquer thinner, IPA and acetone.

PUD-A+DISPERSION A samples were prepared as in the previous examples and stored at 40(C. At the indicated time periods, white pigmented samples, E, F, G, and H were prepared according to Table IV for testing on vinyl. These samples were tested for adhesion, pencil hardness, detergent resistance, window cleaner resistance (for 24 hours) and resistance to 70% isopropanol (for 30 minutes). The results of these tests are presented in Table V.

Adhesion was determined by the crosshatch adhesion test as described in ASTM D 3359.

Pencil hardness was determined according to ASTM D3363.

Detergent resistance was measured as described in AAMA 615-13 after 72 hours immersion at 38° C. for its effect on gloss retention as determined by a gloss meter (Micro-TRI-gloss) manufactured by BYK Gardner GmbH; Appearance after test as determined by visual examination.

Window cleaner testing was done according to AAMA 615-13. Appearance after test as determined by visual examination.

Gloss retention was determined by a gloss meter (Micro-TRI-gloss) manufactured by BYK Gardner GmbH.

70% IPA was measured by a 30 minute spot test at room temperature; appearance after test as determined by visual examination.

TABLE IV

| | Ex. E | Ex. F | Ex. G | Ex. H |
|---|---|---|---|---|
| PUD-A | 78.34 | 77.73 | 76.53 | 75.38 |
| DISPERSION A | 0 | 0.77 | 2.31 | 3.77 |
| % DISPERSION A | 0 | 1 | 3 | 5 |
| ADDITIVE E | 0.12 | 0.12 | 0.12 | 0.12 |
| ADDITIVE F | 0.16 | 0.16 | 0.16 | 0.15 |
| ADDITIVE G | 0.46 | 0.46 | 0.45 | 0.44 |
| SOLVENT B | 1.74 | 1.73 | 1.70 | 1.67 |
| ADDITIVE H | 0.82 | 0.81 | 0.80 | 0.79 |
| TINT A | 18.36 | 18.22 | 17.94 | 17.67 |
| Properties | | | | |
| P/B | 0.49 | 0.49 | 0.49 | 0.49 |
| PVC | 14.75 | 14.75 | 14.75 | 14.75 |
| VOC | 1.99 | 1.98 | 1.94 | 1.91 |
| Volume solids | 32.09 | 32.14 | 32.25 | 32.35 |
| Weight solids | 41.98 | 41.96 | 41.93 | 41.90 |
| Wt/Gal. | 9.79 | 9.78 | 9.76 | 9.74 |

TABLE V

| | Storage | | | | | | | | | | | |
|---|---|---|---|---|---|---|---|---|---|---|---|---|
| | 0 weeks @ 40° C. | | | | 2 weeks @ 40° C. | | | | 4 weeks @ 40° C. | | | |
| Sample | E | F | G | H | E | F | G | H | E | F | G | H |
| Dispersion A | 0% | 1% | 3% | 5% | 0% | 1% | 3% | 5% | 0% | 1% | 3% | 5% |
| Adhesion | 5B | 5B | 5B | 5B | 5B | 5B | 5B | 5B | 5B | 5B | 5B | 5B |
| Pencil hardness | 2H | H | 3H | 3H | H | 2H | 3H | 4H | H | 2H | 3H | 3H |
| Detergent | | | | | | | | | | | | |
| Initial gloss | 44.1 | 26.4 | 42.0 | 26.4 | 29.2 | 22.2 | 28.4 | 30.6 | 23.6 | 24.0 | 28.8 | 26.8 |
| Final gloss | 18.3 | 35.2 | 50.4 | 39.5 | 6.2 | 10.7 | 41.0 | 49.1 | 10.1 | 10.1 | 28.1 | 32.3 |
| Gloss retention | 41.5% | 133.3% | 120% | 149.6% | 21% | 48% | 144% | 160% | 43% | 42% | 98% | 121% |
| Detergent | Micro- | No | No | No | Micro- | Micro- | No | No | Brittle | Cracked | No | No |
| (appearance | cracks | change | change | change | cracked | cracked | change | change | | | change | change |
| after test) | | | | | | | | | | | | |
| Window | no | no | no | no | no | no | no | no | no | no | no | no |
| cleaner | effect | effect | effect | effect | effect | effect | effect | effect | effect | effect | effect | effect |
| 70% IPA | slightly | no | no | no | soft, | soft, | no | no | cracked | slight | no | no |
| | brittle | effect | effect | effect | cracked, | cracked | effect | effect | | stain | effect | effect |
| | | | | | brittle | | | | | | | |

As is apparent by reference to Table V, at 0 weeks (initial), the addition of polycarbodiimide in any amount to the aqueous polyurethane dispersion (PUD) improved the measured physical performance of coatings, adhesives, sealants, paints, primers, topcoats, and composites made therefrom. However, an aqueous polyurethane dispersion (PUD) including 1% polycarbodiimide experienced declined performance over time, such as after two and four weeks storage at 40° C. Aqueous polyurethane dispersions (PUDs) containing 3% and 5% polycarbodiimide showed stabilized physical performance over time after storage at 40° C for two and four weeks.

Samples were also assessed for impact resistance according to ASTM D2794 when made and after four months storage at room temperature. The ASTM test was performed with a Gardner Impact Tester. Briefly, a steel punch having a hemispherical head (diameter of 0.625 in. (15.9 mm)-0.9 kg (2 lbs)) was used. The steel punch was dropped on the coating side (direct impact) and the force (in inch-lbs) was measured. The test was repeated with larger forces until the panel cracked. For example, if the initial test was 80 inch-lbs and there was no crack observed, the test moved to the next level, 100 inch-lbs. If a complete crack of panel was observed at 100 inch-lbs, the impact resistance of this coating was reported as “80 inch-lbs”. The results are presented below in Tables VI and VII.

TABLE VI

| | Storage | | | |
|---|---|---|---|---|
| | 0 weeks @RT | | | |
| Sample | I | J | K | L |
| PUD-A | 100.00 | 99.01 | 97.09 | 95.24 |
| DISPERSION A | 0 | 0.99 | 2.91 | 4.76 |
| Dispersion A | 0% | 1% | 3% | 5% |
| Impact resistance (inch-lbs) | 40 | 100 | 120 | 100 |

TABLE VII

Storage
4 months @RT

| Sample | I | J | K | L |
|---|---|---|---|---|
| Dispersion A | 0% | 1% | 3% | 5% |
| Impact resistance (inch-lbs) | 60 | 100 | 140-160 | 146-160 |

This specification has been written with reference to various non-limiting and non-exhaustive embodiments. However, it will be recognized by persons having ordinary skill in the art that various substitutions, modifications, or combinations of any of the disclosed embodiments (or portions thereof) may be made within the scope of this specification. Thus, it is contemplated and understood that this specification supports additional embodiments not expressly set forth herein. Such embodiments may be obtained, for example, by combining, modifying, or reorganizing any of the disclosed steps, components, elements, features, aspects, characteristics, limitations, and the like, of the various non-limiting embodiments described in this specification. In this manner, Applicants reserve the right to amend the claims during prosecution to add features as variously described in this specification, and such amendments comply with the requirements of 35 U.S.C. § 112(a), and 35 U.S.C. § 132(a).

Various aspects of the subject matter described herein are set out in the following numbered clauses:

Clause 1. A method of stabilizing at least one performance property of an aqueous polyurethane dispersion (PUD), the method comprising adding from >1% to about 5%, based on the weight of the aqueous polyurethane dispersion (PUD), of a polycarbodiimide, wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

Clause 2. The method according to Clause 1, wherein the polycarbodiimide comprises a dispersion.

Clause 3. The method according to Clause 2, wherein the dispersion is a waterborne dispersion.

Clause 4. The method according to any one of Clauses 1 to 3, wherein from 3% to 5% of the polycarbodiimide, based on the weight of the aqueous polyurethane dispersion (PUD), is added.

Clause 5. The method according to any one of Clauses 1 to 4, wherein the polycarbodiimide is aliphatic.

Clause 6. The method according to any one of Clauses 1 to 4, wherein the polycarbodiimide is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

Clause 7. The method according to any one of Clauses 1 to 6, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono functional polyalkylene ether, (vii) a polyol having a molecular weight of less than <400 g/mol, and (viii) a polyamine or amino alcohol having a molecular weight of 32 to 400 g/mol, and wherein the aqueous polyurethane dispersion (PUD) has a hard block content of greater than 50%.

Clause 8. The method according to any one of Clauses 1 to 7, wherein the at least one performance property is stabilized for at least two weeks at 40° C.

Clause 9. The method according to any one of Clauses 1 to 8, wherein the at least one performance property is stabilized for at least four weeks at 40° C.

Clause 10. A method of stabilizing at least one performance property of an aqueous polyurethane dispersion (PUD), the method comprising adding from >1% to 5%, based on the weight of the aqueous polyurethane dispersion (PUD), of a polycarbodiimide, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono fu nctional polyalkylene ether, (vii) a polyol having a molecular weight of less than <400 g/mol, and (viii) a polyamine or amino alcohol having a molecular weight of 32 to 400 g/mol, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

Clause 11. The method according to Clause 10, wherein the polycarbodiimide comprises a dispersion.

Clause 12. The method according to Clause 11, wherein the dispersion is a waterborne dispersion.

Clause 13. The method according to any one of Clauses 10 to 12, wherein from 3% to 5%, based on the weight of the aqueous polyurethane dispersion (PUD), of polycarbodiimide is added.

Clause 14. The method according to any one of Clauses 10 to 13, wherein the polycarbodiimide is aliphatic.

Clause 15. The method according to any one of Clauses 10 to 13, wherein the polycarbodiimide is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

Clause 16. The method according to any one of Clauses 10 to 15, wherein the at least one performance property is stabilized for at least two weeks at 40° C.

Clause 17. The method according to any one of Clauses 10 to 16, wherein the at least one performance property is stabilized for at least four weeks at 40° C.

Clause 18. An aqueous polyurethane dispersion (PUD) having at least one performance property stabilized, comprising the reaction product of (i) a polyisocyanate; (ii) a polymeric polyol having a number average molecular weight of 400 to 8,000 g/mol; (iii) a compound comprising at least one isocyanate-reactive group and an anionic group or potentially anionic group; (iv) an amorphous polyester having a glass transition temperature (Tg) as determined by differential scanning calorimetry (DSC) of less than −30° C., (v) water; (vi) a mono functional polyalkylene ether; (vii) a polyol having a molecular weight of less than <400 g/mol; (viii) a polyamine or amino alcohol having a molecular weight of 32 to 400 g/mol; and (ix) >1% to 5%, based on the weight of the aqueous polyurethane dispersion (PUD), of a polycarbodiimide, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

Clause 19. The aqueous polyurethane dispersion (PUD) according to Clause 18, wherein the polycarbodiimide (ix) comprises from 3% to 5%, based on the weight of the aqueous polyurethane dispersion (PUD).

Clause 20. The aqueous polyurethane dispersion (PUD) according to one of Clauses 18 and 19, wherein the polycarbodiimide (ix) is aliphatic.

Clause 21. The aqueous polyurethane dispersion (PUD) according to one of Clauses 18 and 19, wherein the polycarbodiimide (ix) is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

Clause 22. The aqueous polyurethane dispersion (PUD) according to any one of Clauses 18 to 21, wherein the polycarbodiimide (ix) comprises a dispersion.

Clause 23. The aqueous polyurethane dispersion (PUD) according to Clause 22, wherein the dispersion is a waterborne dispersion.

Clause 24. The aqueous polyurethane dispersion (PUD) according to any one of Clauses 18 to 23, wherein the amorphous polyester (iv) comprises ortho-phthalic anhydride.

Clause 25. The aqueous polyurethane dispersion (PUD) according to any one of Clauses 18 to 24, wherein the amorphous polyester (iv) has a molecular weight of 300 to 3000.

Clause 26. The aqueous polyurethane dispersion (PUD) according to any one of Clauses 18 to 25, wherein the amorphous polyester (iv) has a molecular weight of 1000.

Clause 27. The aqueous polyurethane dispersion (PUD) according to any one of Clauses 18 to 26, wherein the polyisocyanate (i) is selected from the group consisting of 1,6-hexamethylene diisocyanate (HDI), pentamethylene diisocyanate (PDI), isophorone diisocyanate (IPDI), 2,2,4- and 2,4,4-trimethyl-hexamethylene diisocyanate, isomeric bis-(4,4′-isocyanatocyclohexyl)methanes or mixtures thereof of any desired isomer content, 1,4-cyclohexylene diisocyanate, 1,4-phenylene diisocyanate, 2,4- and 2,6-toluene diisocyanate or hydrogenated 2,4- and 2,6-toluene diisocyanate, 1,5-naphthalene diisocyanate, 2,4′- and 4,4′-diphenylmethane diisocyanate, 1,3- and 1,4-bis-(2-isocyanato-prop-2-yl)-benzene (TMXDI), 1,3-bis(isocyanato-methyl)benzene (XDI), and (S)-alkyl 2,6-diisocyanato-hexanoates or (L)-alkyl 2,6-diisocyanatohexanoates.

Clause 28. The aqueous polyurethane dispersion (PUD) according to any one of Clauses 18 to 27, wherein the at least one performance property is stabilized for at least two weeks at 40° C.

Clause 29. The aqueous polyurethane dispersion (PUD) according to any one of Clauses 18 to 28, wherein the at least one performance property is stabilized for at least four weeks at 40° C.

Clause 30. One of a coating, an adhesive, a sealant, a paint, a primer, a topcoat, and a composite comprising the aqueous polyurethane dispersion (PUD) according to any one of Clauses 18 to 29.

Clause 31. A substrate having applied thereto the one of a coating, an adhesive, a sealant, a paint, a primer, a topcoat, and a composite according to Clause 30.

Clause 32. The substrate according to Clause 31, wherein the substrate is selected from the group consisting of polyvinylchloride (PVC), polystyrene (PS), polyvinyl acetate (PVAc), polyvinyl alcohol (PVOH), polyacrylonitrile (PAN), polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), wood, concrete, masonry, textiles, metals, ceramics, composites, and glass.

Clause 33. The substrate according to one of Clauses 31 and 32, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

Clause 34. One of a coating, an adhesive, a sealant, a paint, a primer, a topcoat, and a composite comprising an aqueous polyurethane dispersion (PUD) comprising the reaction product of a polyisocyanate, a polymeric polyol having a number average molecular weight of 400 to 8,000 g/mol, a compound comprising at least one isocyanate-reactive group and an anionic group or potentially anionic group, an amorphous polyester having a glass transition temperature (Tg) as determined by differential scanning calorimetry (DSC) of less than −30° C., water, a mono functional polyalkylene e ther, a polyol having a molecular weight of less than <400 g/mol, a polyamine or amino alcohol having a molecular weight of 32 to 400 g/mol, and >1% to about 5%, based on the weight of the aqueous polyurethane dispersion (PUD), of a polycarbodiimide, wherein the aqueous polyurethane dispersion (PUD) has a hard block content of greater than 50%, and wherein at least one performance property of the coating, adhesive, sealant, paint, primer, topcoat, or composite is stabilized over time, the property selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

Clause 35. The coating, adhesive, sealant, paint, primer, topcoat, or composite according to Clause 34, wherein the polycarbodiimide (ix) comprises from about 3% to about 5%, based on the weight of the aqueous polyurethane dispersion (PUD).

Clause 36. The coating, adhesive, sealant, paint, primer, topcoat, or composite according to one of Clauses 33 and 34, wherein the polycarbodiimide (ix) comprises a waterborne dispersion.

Clause 37. The coating, adhesive, sealant, paint, primer, topcoat, or composite according to any one of Clauses 33 to 36, wherein the polycarbodiimide (ix) is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

Clause 38. The coating, adhesive, sealant, paint, primer, topcoat, or composite according to any one of Clauses 33 to 37, wherein the at least one performance property is stabilized for at least two weeks at 40° C.

Clause 39. The coating, adhesive, sealant, paint, primer, topcoat, or composite according to any one of Clauses 33 to 38, wherein the at least one performance property is stabilized for at least four weeks at 40° C.

Clause 40. A substrate having applied thereto the one of a coating, an adhesive, a sealant, a paint, a primer, a topcoat, and a composite according to any one of Clauses 33 to 40.

Clause 41. The substrate according to Clause 40, wherein the substrate is selected from the group consisting of polyvinylchloride (PVC), polystyrene (PS), polyvinyl acetate (PVAc), polyvinyl alcohol (PVOH), polyacrylonitrile (PAN), polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), wood, concrete, masonry, textiles, metals, ceramics, composites, and glass.

Clause 42. The substrate according to one of Clauses 41 and 42, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

Clause 43. A method of stabilizing at least one performance property of one of a coating, an adhesive, a sealant, a paint, a primer, a topcoat, and a composite, the method comprising adding from >1% to 5%, based on the weight of an aqueous polyurethane dispersion (PUD), of a polycarbodiimide, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono functional polyalkylene ether, (vii) a polyol having a molecular weight of less than <400 g/mol, and (viii) a polyamine or amino alcohol having a molecular weight of 32 to 400 g/mol, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

Clause 44. The method according to Clause 43, wherein the polycarbodiimide comprises a dispersion.

Clause 45. The method according to one of Clauses 43 and 44, wherein the dispersion is a waterborne dispersion.

Clause 46. The method according to any one of Clauses 43 to 45, wherein from 3% to 5%, based on the weight of the aqueous polyurethane dispersion (PUD), of polycarbodiimide is added.

Clause 47. The method according to any one of Clauses 43 to 46, wherein the polycarbodiimide is aliphatic.

Clause 48. The method according to any one of Clauses 43 to 47, wherein the polycarbodiimide is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

Clause 49. The method according to any one of Clauses 43 to 48, wherein the at least one performance property is stabilized for at least two weeks at 40° C.

Clause 50. The method according to any one of Clauses 43 to 49, wherein the at least one performance property is stabilized for at least four weeks at 40° C.

Clause 51. A method of stabilizing at least one performance property of one of a coating, an adhesive, a sealant, a paint, a primer, a topcoat, and a composite, comprising an aqueous polyurethane dispersion (PUD), the method comprising adding to the aqueous polyurethane dispersion (PUD) from >1% to 5%, based on the weight of the aqueous polyurethane dispersion (PUD), of a polycarbodiimide, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono fu nctional polyalkylene ether, (vii) a polyol having a molecular weight of less than <400 g/mol, and (viii) a polyamine or amino alcohol having a molecular weight of 32 to 400 g/mol, wherein the aqueous polyurethane dispersion (PUD) has a hard block content of greater than 50%, and wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

What is claimed is:

1. A method of stabilizing at least one performance property of an aqueous polyurethane dispersion (PUD), the method comprising adding from >1% to about 5%, based on the weight of the aqueous polyurethane dispersion (PUD), of a polycarbodiimide,
wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

2. The method according to claim 1, wherein the polycarbodiimide comprises a waterborne dispersion.

3. The method according to claim 1, wherein from about 3% to about 5% of the polycarbodiimide, based on the weight of the aqueous polyurethane dispersion (PUD), is added.

4. The method according to claim 1, wherein the polycarbodiimide is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

5. The method according to claim 1, wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (vi) a mono functional polyalkylene ether, (vii) a polyol having a molecular weight of less than <400 g/mol, and (viii) a polyamine or amino alcohol having a molecular weight of 32 to 400 g/mol, and wherein the aqueous polyurethane dispersion (PUD) has a a hard block content of greater than 50%.

6. The method according to claim 1, wherein the at least one performance property is stabilized for at least two weeks at 40° C.

7. The method according to claim 1, wherein the at least one performance property is stabilized for at least four weeks at 40° C.

8. One of a coating, an adhesive, a sealant, a paint, a primer, a topcoat, and a composite comprising an aqueous polyurethane dispersion (PUD) comprising the reaction product of:
(i) a polyisocyanate;
(ii) a polymeric polyol having a number average molecular weight of 400 to 8,000 g/mol;
(iii) a compound comprising at least one isocyanate-reactive group and an anionic group or potentially anionic group;
(iv) an amorphous polyester having a glass transition temperature (Tg) as determined by differential scanning calorimetry (DSC) of less than −30° C.,
(v) water;
(vi) a mono functional polyalkylene ether;
(vii) a polyol having a molecular weight of less than <400 g/mol;
(viii) a polyamine or amino alcohol having a molecular weight of 32 to 400 g/mol; and
(ix) >1% to about 5%, based on the weight of the aqueous polyurethane dispersion (PUD), of a polycarbodiimide,
wherein the aqueous polyurethane dispersion (PUD) has a hard block content of greater than 50%, and wherein at least one performance property of the coating, adhesive, sealant, paint, primer, topcoat, or composite is stabilized over time, the property selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.

9. The coating, adhesive, sealant, paint, primer, topcoat, or composite according to claim 8, wherein the polycarbodiimide (ix) comprises from about 3% to about 5%, based on the weight of the aqueous polyurethane dispersion (PUD).

10. The coating, adhesive, sealant, paint, primer, topcoat, or composite according to claim 8, wherein the polycarbodiimide (ix) comprises a waterborne dispersion.

11. The coating, adhesive, sealant, paint, primer, topcoat, or composite according to claim 8, wherein the polycarbodiimide (ix) is selected from the group consisting of N,N′-dicyclohexylcarbodiimide (DCC), N,N′-diisopropylcarbodiimide (DIC), 1-ethyl-3-(3-dimethylaminopropyl)carbodiimide (EDC), and 1-cyclohexyl-(2-morpholinoethyl)carbodiimide metho-p-toluene sulfonate (CMCT).

12. The coating, adhesive, sealant, paint, primer, topcoat, or composite according to claim 8, wherein the at least one performance property is stabilized for at least two weeks at 40° C.

13. The coating, adhesive, sealant, paint, primer, topcoat, or composite according to claim 8, wherein the at least one performance property is stabilized for at least four weeks at 40° C.

14. A substrate having applied thereto the one of a coating, an adhesive, a sealant, a paint, a primer, a topcoat, and a composite according to claim 8.

15. The substrate according to claim 14, wherein the substrate is selected from the group consisting of polyvinylchloride (PVC), polystyrene (PS), polyvinyl acetate (PVAc), polyvinyl alcohol (PVOH), polyacrylonitrile (PAN), polyamide (PA), polyethylene (PE), high-density polyethylene (HDPE), low-density polyethylene (LDPE), polyethylene terephthalate (PET), polytetrafluoroethylene (PTFE), polyester (PES), polypropylene (PP), polyurethane (PU), thermoplastic polyurethane, epoxy, polycarbonate (PC), acrylonitrile butadiene styrene (ABS), polycarbonate/acrylonitrile butadiene styrene (PC/ABS), polyethylene/acrylonitrile butadiene styrene (PE/ABS), polymethyl methacrylate (PMMA), polybenzimidazole (PBI), polyoxymethylene (POM), wood, concrete, masonry, textiles, metals, ceramics, composites, and glass.

16. The substrate according to claim 14, wherein the substrate is selected from the group consisting of floors, windows, doors, window frames, door frames, window shutters, window surrounds railing, gates, pillars, arbors, pergolas, trellises, gazebos, posts, fencing, pipes and fittings, wire and cable insulation, automobile components, credit cards, cladding and siding.

17. A method of stabilizing at least one performance property of one of a coating, an adhesive, a sealant, a paint, a primer, a topcoat, and a composite, comprising an aqueous polyurethane dispersion (PUD), the method comprising adding to the aqueous polyurethane dispersion (PUD) from >1% to 5%, based on the weight of the aqueous polyurethane dispersion (PUD), of a polycarbodiimide,
wherein the aqueous polyurethane dispersion (PUD) comprises the reaction product of (i) a polyisocyanate, (ii) a polymeric polyol having a number average molecular weight of 400 to 8,000 g/mol, (iii) a compound comprising at least one isocyanate-reactive group and an anionic group or potentially anionic group, (iv) an amorphous polyester having a glass transition temperature (Tg) as determined by differential scanning calorimetry (DSC) of less than −30° C., (v) water, (v i) a mono functional polyalkylene ether, (vii) a polyol having a molecular weight of less than <400 g/mol, and (viii) a polyamine or amino alcohol having a molecular weight of 32 to 400 g/mol,
wherein the aqueous polyurethane dispersion (PUD) has a hard block content of greater than 50%, and
wherein the at least one performance property is selected from the group consisting of adhesion measured according to ASTM D 3359, detergent resistance measured according to AAMA 615-13, window cleaner resistance measured according to AAMA 615-13, 70% isopropyl alcohol resistance, pencil hardness measured according to ASTM D3363, impact resistance measured according to ASTM D2794, viscosity, pH, acid value, and pot life.
